(19) United States
(12) Patent Application Publication
(10) Pub. No.: US 2009/0290356 A1
(43) Pub. Date: Nov. 26, 2009

(54) Light-Emitting Diode Lampshade with Heat-Radiating Effect

(75) Inventor: Chih-Peng Chen, Sinjhuang City (TW)

Correspondence Address: NIKOLAI & MERSEREAU, P.A., 900 SECOND AVENUE SOUTH, SUITE 820, MINNEAPOLIS, MN, 55402, US

(73) Assignee: ASIA VITAL COMPONENTS CO., LTD., Sinjhuang City (TW)

(21) Appl. No.: 12/124,473

(22) Filed: May 21, 2008

(51) Int. Cl. F21V 7/00

(52) U.S. Cl. 362/310; 362/351

(57) ABSTRACT

A light-emitting diode (LED) lampshade with heat-radiating effect is made of a heat-conducting material, and has a plane contact section and an extension section extended from at least one side of the contact section. The plane contact section has at least one LED module mounted thereon. The extension section is so configured that it not only converges and reflects light emitted from the LED module, but also provides a large surface area in direct contact with ambient air. When the LED module produces heat during the operation thereof, the produced heat is transferred from the contact section of the LED lampshade to the extension section and dissipated into ambient air directly from the extension section.

### FIELD OF THE INVENTION

The present invention relates: to a light-emitting diode (LED) lampshade, and more particularly to an LED lampshade with heat-radiating effect.

### BACKGROUND OF THE INVENTION

Super high brightness LEDs and white light LEDs have been maturely developed and applied to desk lamps, projector lamps, etc. It is a trend to use LED lamps as the major indoor lighting fixtures to replace the existing, incandescent (tungsten-filament) lamps.

In the traditional incandescent lamp, the tungsten filament thereof glows and emits light when a large amount of current passes therethrough. In contrast to the conventional tungsten filament lamp, the LED is a semiconductor element. When the electrons and holes in the semiconductor material of the LED are coupled to each other, energy is released in the form of light, and that is why the LED emits light. Only a very small amount of current is required for the. LED to emit considerably bright light.

However, while the LED emits bright light, it also produces a large amount of heat. In the event the produced heat is not timely dissipated into ambient environment, the accumulated heat would not only shorten the usable life of the LED, but also damage other nearby electronic elements to even lead to a fire. Therefore, it has become a quite important issue in the LED field to find out a solution for timely dissipating the heat produced by the LED.

A conventional LED lampshade is provided for shading LEDs mounted therein, and an inner surface of the LED lampshade serves to converge or refract the light emitted from the LEDs. However, the conventional LED lampshade does not provide any heat-radiating function. Therefore, when the heat produced by the working LEDs leads to a high temperature in the lampshade, the LEDs together with the lampshade might become burned out. To obviate such problem, additional heat sinks, heat pipes, radiating fins and/or a cooling fan must be provided for dissipating the heat produced by the LEDs. For this purpose, the conventional LED lampshade must be configured in consideration of the size, the shape, and the arrangement of the heat-radiating elements to be added thereto. As a result, the conventional LED lampshade generally has a considerably large volume and high manufacturing cost. In summary, the conventional LED lampshade has the following disadvantages of: (1) having poor heat radiating effect; (2) requiring additional heat dissipating elements; and (3) requiring high manufacturing cost.

### SUMMARY OF THE INVENTION

A primary object of the present invention is to provide an LED lampshade that provides good heat-radiating effect without the need of mounting additional heat dissipating elements.

To achieve the above and other objects, the LED lampshade according to the present invention is made of a heat-conducting material and has a simple structure but a large heat-radiating area. The LED lamp shade of the present invention includes a plane contact section and an extension section extended from at least one side of the contact section. The plane contact section has at least one LED module mounted thereon. The extension section is so configured that it not only converges and reflects light emitted from the LED module and protects the LED module, but also provides a large surface area in direct contact with ambient air. Whereby when the LED module produces heat during the operation thereof, the produced heat is transferred from the contact section of the LED lampshade to the extension section and dissipated into ambient air directly from the extension section.

Therefore, the LED lampshade of the present, invention has the following advantages: (1) it has simple structure to reduce the manufacturing cost thereof; (2) it is made of a heat-conducting material to serve as a heat-radiating element without the need of mounting any other heat-radiating element to the LED lampshade; and (3) it provides large surface area to enable quick heat dissipation.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a preferred embodiment of the present invention;

FIG. 2 is an assembled view of FIG. 2; and

FIG. 3 is a side view showing the function of the LED lampshade of the present invention.

### DETAILED DESCRIPTION OF THE PREFERRED EMBODIMENTS

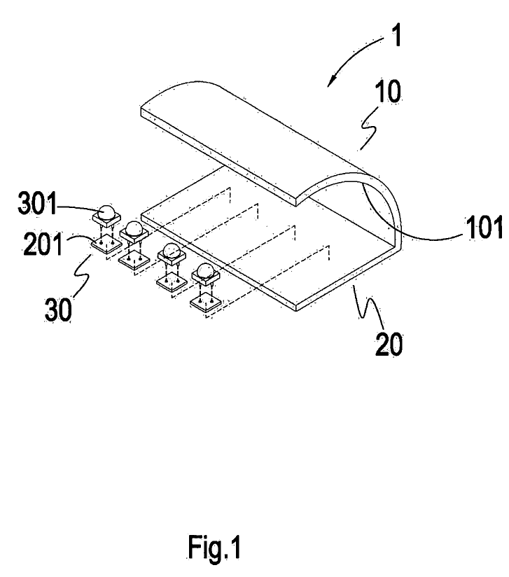

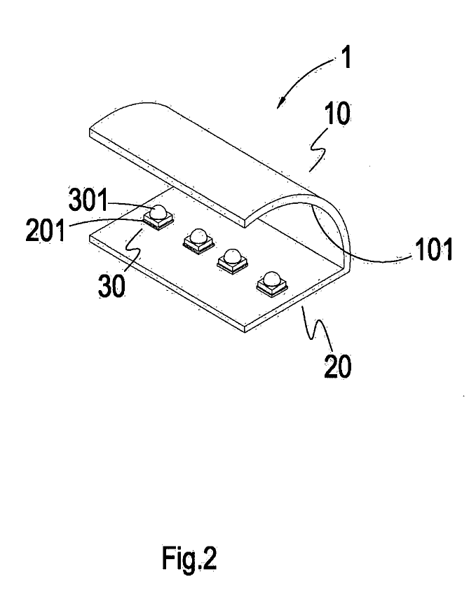

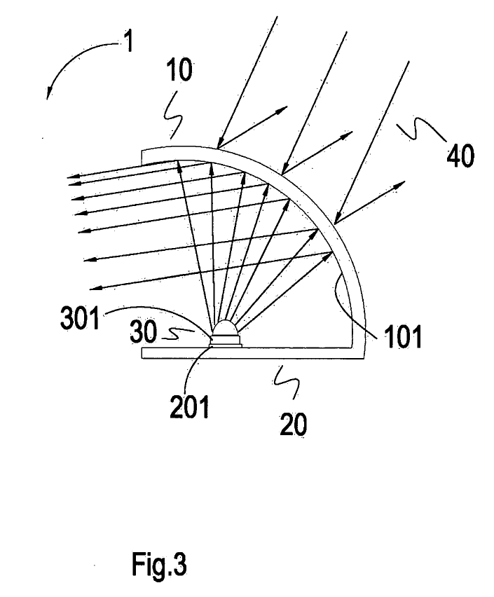

Please refer to FIGS. 1 and 2 that are exploded and assembled perspective views, respectively, of a light-emitting diode (LED) lampshade 1 with heat-radiating effect according to a preferred embodiment of the present invention. As shown, the LED lampshade 1 is made of a heat-conducting material, which may be copper or aluminum, and includes a plane contact section 20 and an extension section 10 extended from at least one side of the contact section 20. At least one LED module 30 consisting of at least one LED can be laid on the contact section 20. The extension section 10 serves to block external interfering light 40 (see FIG. 3) and protect the LED module 30 against damage by other factors. Also, the extension section 10 is so shaped that an inner surface thereof is able to converge and reflect the light emitted from the LED module 30. In addition, the extension section 20 is configured to have a large surface area, which provides an increased contact area between the LED lampshade 1 and ambient air to enable quick and direct dissipation of the heat generated by the LED module 30 into ambient environment. Therefore, the extension section 10 of the LED lampshade 1 also functions as a heat-radiating element. With these arrangements, it is not necessary to mount any additional heat radiating element to the LED lampshade 1.

Please refer to FIG. 3. The LED module 30 includes at least one LED 301 and a circuit board 201 for driving the LED 301. The circuit board 201 is arranged on the contact section 20 with the LED 301 inserted onto the circuit board 201. When the circuit board 201 drives the LED 301 to emit light, it also produces heat. The produced heat is transferred from the contact section 20 to the extension section 10 of the LED lampshade 1. Since the extension section 10 has large surface area and is in direct contact with ambient air, heat transferred to the extension section 10 can be quickly dissipated into ambient air. Accordingly, the LED lampshade 1 itself is able to effectively dissipate the heat produced by the LED module 30 without the need of mounting any additional heat-radiating element. Therefore, the LED lampshade 1 has simplified structure and can be manufactured a reduced cost.

In order to achieve even better light-reflecting effect, a reflecting layer 101 may be coated over the inner surface of the extension section 10 to reflect light beams emitted from the LED module 30 and converged by the LED lampshade 1. With these arrangements, the light emitted from the LED module 30 maybe reflected toward the same side without becoming scattered to decrease the illumination effect of the LED module 30.

The present invention has been described with a preferred embodiment thereof and it is understood that many changes arid modifications in the described embodiment can be carried but without departing from the scope and the spirit of the invention that is intended to be limited only by the appended claims.

What is claimed is:

1. A light-emitting diode (LED) lampshade with heat-radiating effect, comprising a plane contact section having at least one LED module mounted thereon and an extension section extended from at least one side of the contact section, and both of the plane contact section and the extension section being made of a heat-conducting material; whereby when the LED module produces heat during operation thereof, the produced heat is transferred from the contact section to the extension section and dissipated in ambient air directly from the extension section.

2. The LED lampshade with heat-radiating effect as claimed in claim 1, wherein the extension section is provided on an inner surface with a reflecting layer for reflecting light emitted from the LED module.

3. The LED lampshade with heat-radiating effect as claimed in claim 1, wherein the heat-conducting material is copper.

4. The LED lampshade with heat-radiating effect as claimed in claim 1, wherein the heat-conducting material is aluminum.

5. The LED lampshade with heat-radiating effect as claimed in claim 1, wherein the LED module includes at least one LED.
